(19) United States
(12) Patent Application Publication
(10) Pub. No.: US 2019/0356707 A1
(43) Pub. Date: Nov. 21, 2019

(54) Automatic RTP Session Rebuilding Method for SIP RTP Server

(71) Applicant: Mohammed Anisur Rahman, Lewisville, TX (US)

(72) Inventor: Mohammed Anisur Rahman, Lewisville, TX (US)

(21) Appl. No.: 15/981,818

(22) Filed: May 16, 2018

(51) Int. Cl. H04L 29/06

(52) U.S. Cl. CPC H04L 65/1083; H04L 65/1046; H04L 65/105; H04L 65/1006; H04L 65/80

(57) ABSTRACT

In existing IP telephony RTP session table cannot be regenerated during failure. It requires periodic session mirroring. All calls established between mirroring are dropped during switchover. RTP session mirroring is not possible during software crash or manual software upgrade. In this invention all sessions are rebuild from incoming voice IP packets without having any knowledge of the lost RTP session table. To achieve this RTP server always assigns predetermined paired ports for each session. In the recovery phase the RTP session table is rebuilt mathematically from the very first incoming voice packet. So in the event of the active RTP server failure the standby RTP server resumes call sessions without interruption.

### BACKGROUND OF THE INVENTION

IP telephony is ubiquitous in today's society. During failure call drops due to existing methodology of the RTP session table generation procedure. This invention resolves the issue of call disruption during RTP server failure by adopting new RTP session table recovery algorithm.

### BRIEF SUMMARY OF THE INVENTION

In the event of failure this invention enables RTP session table to be mathematically rebuilt from incoming call data (RTP packets).

### BRIEF DESCRIPTION OF THE SEVERAL VIEWS OF THE DRAWING

FIG. 1A shows the general SIP call flow and the new method of port allocation by RTP server.

FIG. 1B shows the session number and their predetermined allocated port numbers.

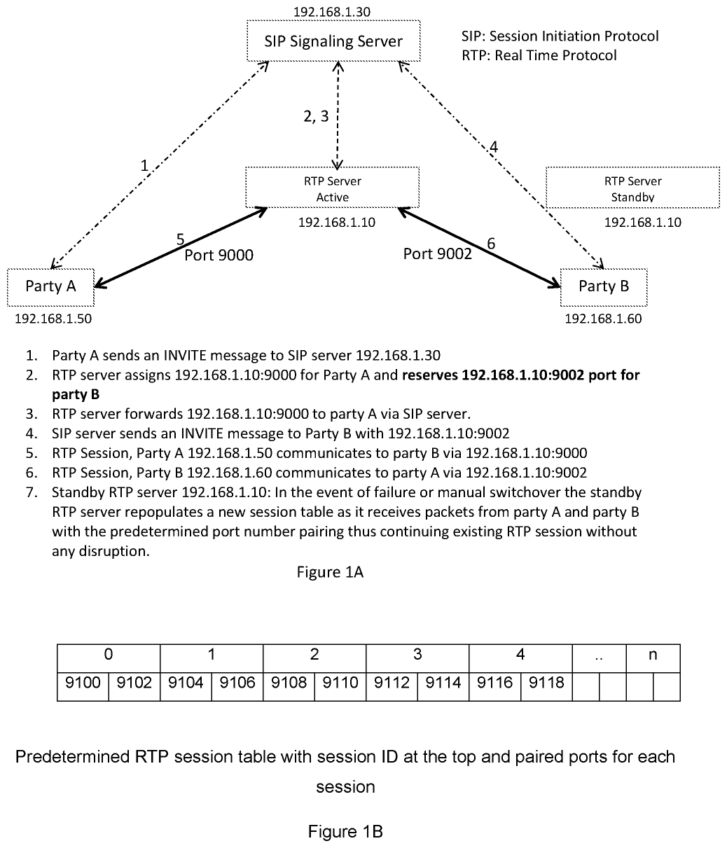

### DETAILED DESCRIPTION OF THE INVENTION

In existing IP telephony RTP session table cannot be regenerated during failure. It requires periodic session mirroring. All calls established between mirroring are dropped during switchover. RTP session mirroring is not possible during software crash or manual software upgrade.

In this invention all sessions are rebuild from incoming voice IP packets without having any knowledge of the lost RTP session table.

To achieve this RTP server always assigns predetermined paired port for each session. In the recovery phase the RTP session table is rebuilt mathematically from the very first incoming voice packet.

### Advantages:

1. In the event of the active RTP server failure the standby RTP server resumes call sessions without interruption.
2. Manual software upgrades without interruption of existing call-sessions.
3. Open the door for auto software upgrade without any maintenance window.
4. If software hangs the RTP server will restart and rebuilds all sessions.
5. Manual RTP server switchover without interruption of existing call-sessions.

### Mathematical Algorithm

Calculate port:
if port_number mod 4=0; then Party=Party-A;
if port_number mod 4=2; then Party=Party-B;
   Calculate pair port for A: received port+2;
   Calculate pair port for B: received port−2;
   Calculate session ID:
Session ID=(received port−start port)/4 (when data receiver from Party-A)
Session ID=(pair port−start port)/4 (when data receiver from Party-B)
(Note: Only divide by 4, if result of first part is greater than zero)

1. This invention enables RTP sessions to be mathematically rebuilt from incoming voice IP packets without having any prior knowledge of the RTP session.
